(19) United States
(12) Patent Application Publication
(10) Pub. No.: US 2020/0170358 A1
(43) Pub. Date: Jun. 4, 2020

(54) Jewelry Article Enhanced with Nail Applique Backing, and Method of Making

(71) Applicant: ICC Global IP Holdings, Inc., Clifton, NJ (US)

(72) Inventor: Fa Young Park, Clifton, NJ (US)

(73) Assignee: ICC Global IP Holdings, Inc., Clifton, NJ (US)

(21) Appl. No.: 16/699,056

(22) Filed: Nov. 28, 2019

Related U.S. Application Data
(60) Provisional application No. 62/774,107, filed on Nov. 30, 2018.

(51) Int. Cl. A44C 15/00; A45D 29/00; A61Q 3/02

(52) U.S. Cl. CPC A44C 15/005; A45D 2200/052; A61Q 3/02; A45D 29/001

(57) ABSTRACT

The present invention comprises a multilayered jewelry article, and method of making, comprising stones 2 (synthetic, real, glass, plastic, etc.), wherein the appearance of the stones is enhanced by applying nail polish, or a nail appliqué 1, to the back surface 14 of at least one stone, or to the front surface 18 of the metal casting that the stone is framed in. The nail polish or nail appliqué comprises colors and/or materials (e.g. glitter, foils, mica, etc.) that are reflected through the front surface of the stone to give each stone a unique decorative appearance. The stones may be translucent colored or clear. The nail appliqué comprises an adhesive layer applied atop a removable substrate; and a first semi-dried nail enamel and/or metallic layer applied atop said adhesive layer; and the adhesive layer adheres to the front surface of the jewelry casting upon removal of the substrate.

### PRIORITY CLAIM

This utility patent application claims priority to U.S. Provisional Patent Application Ser. No. 62/774,107, filed on Nov. 30, 2018, which is incorporated herein by reference in its entirety.

### FIELD

This disclosure generally relates to jewelry with an enhanced appearance of the stones due to nail polish or nail appliqués being applied to the back surface of the stones, or the front surface of the jewelry casting.

### BACKGROUND

Modern costume or fashion jewelry incorporates a wide range of materials, from high-end crystals, cubic zirconia simulated diamonds, and semi-precious gemstones, to inexpensive synthetic glass or plastic stones. Metals, such as for casting around the stones, include gold-plated or silver-plated brass, and sometimes vermeil or sterling silver, brass, bronze and copper. Lower-priced jewelry may still use gold plating over pewter, nickel or other metals.

The Costume Jewelry market is not insignificant, e.g. it was $30,200 million in the U.S. in 2018 and is expected to reach $52,400 million by the end of 2025, growing at a CAGR of 7.1% between 2019 and 2025.

Semi-precious gemstones are those that consist of any natural gemstones excluding sapphire, ruby, or emerald. A synthetic gem is a man-made, lab produced material with essentially the same chemical composition, crystal structure and optical and physical properties as the natural gem material.

Inexpensive vintage and current fashion jewelry comprise, for example, colored cabochons made of plastic or glass of any color. Cabochons have a domed-shaped top and a flat or bluntly faceted bottom surface. Variations may be slightly flattened, but they are always smooth on top. They come in varied shape such as oval, round, and pear; and are usually highly polished but may be frosted in glass examples. These synthetic stones are seen in a variety of colors including varying shades of pink, blue, and green, but the decorative appearance of the stones has been limited. For example, the decorations of the stones comprise: 1) splashes of color that are applied to the front of the stone (e.g. painted on the top surface); and 2) a pieces of paper, stickers, or layers of foil of varying colors applied to the back of a clear stone.

As such, there is a need within the fashion jewelry industry, especially for cosmetic jewelry to enhance the appearance of the stones with a variety of patterns and designs that appear on the stone top surface. The jewelry comprises primarily non-precious gemstones, plastic or glass stones, and synthetic lab grown gemstones, which are colored or clear, translucent or opaque stones. These new designs are needed to differentiate and significantly improve the decorative appearance of cosmetic jewelry over what is readily available within the marketplace, but without significantly increasing the price.

### SUMMARY

In an embodiment, the present invention comprises a jewelry article comprising, a liquid nail polish, or a nail appliqué, applied to the back surface of at least one stone within the jewelry article, or applied to a front surface of a casting that is applied to the stone back surface; wherein the stone is transparent or opaque, and clear or colored; and wherein the nail polish, or the nail appliqué, comprises a color and/or a pattern that is visible on the front surface of the stone. The stones are in a variety of shapes, such as: cabochons with a domed-shaped top and a flat or bluntly faceted bottom surface; to glass and plastic flat surfaces on both top and bottom; and to gemstone shapes well known in the art (faceted and non-faceted; variety of shapes).

In another embodiment, the present invention comprises a method of making a jewelry article comprising an enhanced appearance, comprising the following steps. In step one, providing liquid nail polish, or a multilayered nail appliqué, comprising at least one layer of colored nail enamel (polish or appliqué), and/or a decorative material. In step two, providing a jewelry article with at least one stone with a back surface, a front surface, and at least one side surface. In step three, applying the liquid nail polish, or the nail appliqué, to the stone back surface, or to a casting front surface that is affixable to the stone back surface. In step four, affixing the casting to the stone to create a multilayered article comprising from front to back, e.g.: the stone, the nail polish or nail appliqué, and the casting front surface and/or casting side. In another embodiment with casting covering part of a stone front surface, the multilayered article comprises from front to back: the casting top surface; the stone(s); the liquid nail polish, or the nail appliqué; and optionally, the casting front surface and/or casting side

In an embodiment, the nail enamel is a semi-dried or dried nail appliqué, which adheres to and dries when attached to the stone back surface.

In an embodiment, the decorative material comprises one or more of: glitter, mica, metallic foil layer or bits, or other patterned material, that has an enhanced appearance, especially when combined with the nail enamel or appliqué lying beneath it.

In an embodiment, the nail appliqué comprises an adhesive layer that is exposed when removing a substrate back strip, and said adhesive layer is able to stick to the jewelry's casting front surface.

In another embodiment, the top layer of the nail appliqué, or the back of the stone, comprises an adhesive to enable the appliqué to remain glued to the stone back surface. This embodiment is especially applicable when the jewelry article does not have a casting on the stone back surface (e.g. just a casting top surface and/or a casting side without a casting front surface).

The jewelry articles of the present invention have an enhanced appearance because the nail polish or nail appliqué creates a multitude of irregular and brilliant reflections from light reflecting through the stone and off the surface of the nail polish, as compared to a plain stone, or a stone backed with paper or stickers.

In an embodiment, the jewelry article using a nail appliqué comprises: casting on at least the back of the article; at least one stone; and an adhesive layer applied atop a removable substrate; and a first nail enamel layer applied atop said adhesive layer and having a first color, said first enamel layer comprising partially dried or fully dried enamel; and wherein the adhesive layer is able to adhere to the jewelry casting front surface upon removal of the substrate.

In another embodiment, the jewelry article using a nail appliqué comprises: casting on at least the back of the article; at least one stone; and an adhesive layer applied atop a removable substrate; and a first metallic layer applied atop said adhesive layer, wherein the metallic layer comprises a glitter, a mica, a metallic foil layer or bits, or a decorative pattern; and wherein the adhesive layer is able to adhere to the jewelry casting front surface upon removal of the substrate.

In another embodiment, the jewelry article using a nail appliqué comprises: casting; at least one stone; and an adhesive layer applied atop a first nail enamel layer; and a removeable substrate or clear plastic layer applied atop said adhesive layer, wherein the adhesive layer is able to adhere to the back surface of a jewelry stone upon removal of the substrate or clear plastic layer. The first nail enamel layer comprises a first color, of partially dried or fully dried enamel; or, a metallic layer comprising a glitter, a mica, a metallic foil layer or bits, or a decorative pattern.

In another embodiment with two opposing layers of adhesive, the jewelry article using a nail appliqué comprises: casting; at least one stone with an adhesive layer on the stone back surface (e.g. clear glue); an adhesive layer applied atop a removable substrate; and a first nail enamel layer applied atop said adhesive layer and having a first color, said first enamel layer comprising partially dried or fully dried enamel; and wherein the adhesive layer is able to adhere to the jewelry casting front surface upon removal of the substrate.

In another embodiment with one middle layer of adhesive, the jewelry article using a nail appliqué or liquid nail polish, comprises: casting; at least one stone with an adhesive layer on the stone back surface (e.g. clear glue); and a first nail enamel layer applied atop having a first color, said first enamel layer comprising partially dried or fully dried enamel; and a substrate layer able to protect the enamel layer from wear and tear.

The nail appliqués may further comprise a second nail enamel layer having a second color different than said first color, or a metallic layer, applied atop said first enamel layer, said second enamel layer comprising partially dried or fully dried colored, clear, opaque, or neon enamel. The metallic layer comprises a glitter, a mica, a metallic foil layer or bits, or a decorative pattern.

In the various embodiment, the stones used herein may be synthetic (lab grown, glass, plastic, etc.) or a natural product of nature (e.g. precious gemstones).

### BRIEF DESCRIPTION OF THE DRAWINGS

The drawings constitute a part of this specification and include exemplary embodiments to the invention, which may be embodied in various forms. It is to be understood that, in some instances, various aspects of the invention may be shown exaggerated, enlarged or otherwise spatially modified to facilitate an understanding of the invention.

FIG. 1 is an image of a necklace with a plurality of stones, each stone having a nail appliqué applied to the back surface of the stone, and wherein the appliqué comprises a glitter or fish scale surface.

FIG. 2 is an image of a pair of green emerald earrings with a silver glitter nail appliqué applied to the back surface of each stone, in which the right earring shows the stones' and appliqué parts and the left earring shows the casting parts.

FIG. 3 is an image of the process of making the enhanced jewelry using nail appliqués in a four or five step process.

FIG. 4 is an illustration of the nail appliqué of FIG. 3 cut along the cross-sectional line C-C, showing the layers of an exemplary nail appliqué.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

As used herein, the term “substantially” refers to a geometric shape that one of ordinary skill in the art would readily recognize as being the shape referred to.

The present invention comprises liquid nail enamel, or nail appliqués, being applied to the back surface of at least one stone within a jewelry article, or to the front surface of the casting.

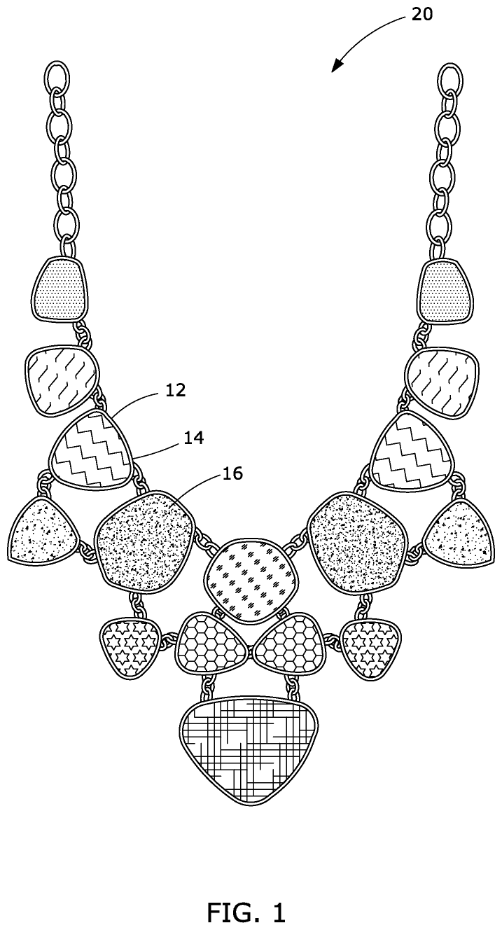

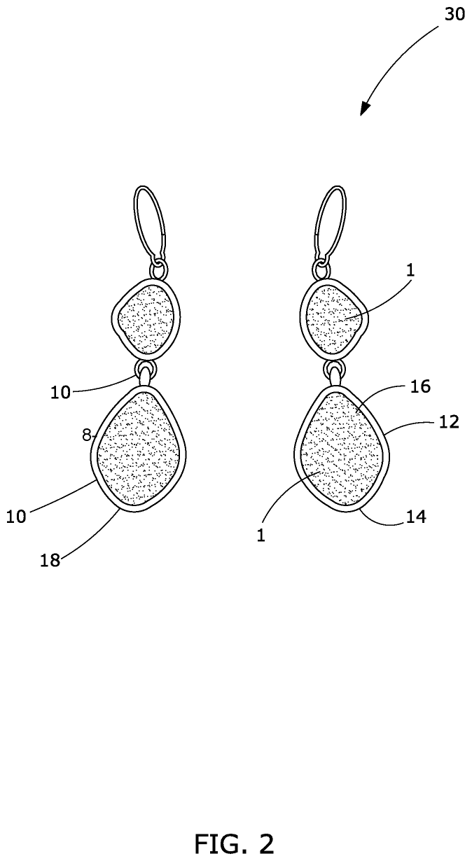

FIGS. 1 and 2 illustrate exemplifications of a necklace 20 and a pair of earrings 30, respectively, wherein the stones comprise a front surface 16, a back surface 14, and at least one side surface 12, all of which may comprise various shapes (e.g. curved, flat, facets, etc.).

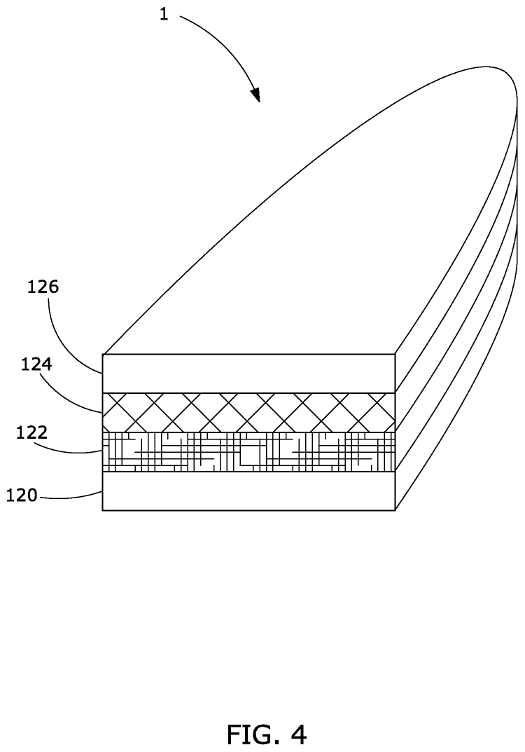

In an embodiment, liquid nail polish, or a nail appliqué 1 is applied either to the back surface 14 of the stone, or to the front surface of the metal casting (e.g. FIG. 4, casting part 18) that the stone is then fixed into.

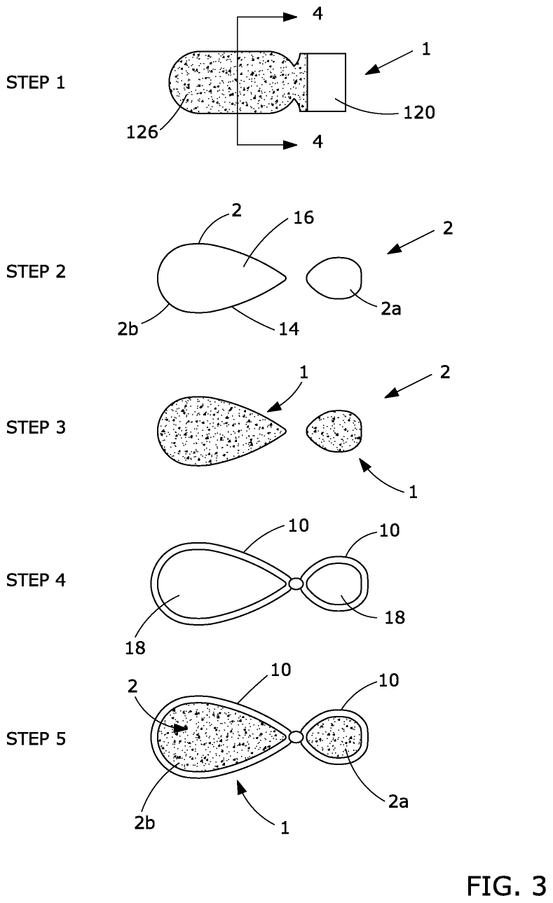

FIG. 3 illustrates a four-step exemplary process for using a nail appliqué 1 applied to the stone comprising the use of a nail appliqué 1 with a silver glitter layer; an oval-shaped, faceted transparent synthetic stone 2; and a metal casting 10 surrounding the sides 12 of the stone 2, and metal casting front surface 18 covering the stone 14 back surface. in one embodiment. In another embodiment, metal casting 10 surrounds the stone's sides 12 and and/or metal casting 8 covers part of the stone's front surface 16.

FIG. 4 is a cross-sectional view of the nail appliqué 1 of FIG. 3, illustrating one embodiment of the multiple layers within an appliqué.

Nail Appliqués

In an embodiment, the nail appliqués can comprise one layer of color and/or one layer of a pattern material (e.g. metallic, glitter, bits of metal foil, mica, etc.); and may further comprise a top coat of clear nail polish. For example, the nail appliqués may comprise those as disclosed in United States Patent Application 20050255061 A1 that was published on Nov. 17, 2005 to the present inventor, and entitled “Dry nail polish applique and method of manufacturing same”, the entire contents of which are hereby incorporated by reference in its entirety.

In another embodiment, the nail appliqué comprises as disclosed in U.S. Pat. No. 9,655,430 B2 that issued May 23, 2017 and entitled: “Double Colored Nail Applique Having a Ultra-Violet Cured Layer, Method of Making and Using”; and U.S. Pat. No. 9,655,429 B2 that issued May 23, 2017 and entitled: “Metallic foil nail appliques”.

In another embodiment, the nail appliqués can comprise more than one decorative layer, such as disclosed in U.S. Pat. No. 8,905,044 B2, that issued on Dec. 9, 2014 to the present inventor, and entitled “Multi-layered color-enhancing nail applique”′.

All of the aforementioned patents and patent applications are to same inventor as the present invention, and the entire contents of these applications are incorporated herein by reference.

FIG. 4 is a cross-sectional view of a nail appliqué, showing the multiple layers: substrate 120; adhesive 122; first enamel color or decorative material (e.g. metallic) 124; and (optional) second enamel color, or metallic, 126. Layer 126 combines with layer 124 to make a unique decoration or color. A metallic layer 124 or 126 comprises one or more of: glitter; mica; metallic foil layer or bits; or a decorative pattern (e.g. fish scales).

For example, as illustrated in FIG. 4 the nail polish appliqué 1 may comprise: an adhesive layer 122 applied atop a removable substrate 120 (e.g. exposable when removing a back strip/substrate); a first nail enamel layer 124 applied atop said adhesive layer 122 and having a first color, said first enamel layer comprising partially dried or fully dried enamel. Alternatively, the first nail enamel layer 124 comprises a metallic layer, as illustrated by the silver glitter nail appliqué 1 in FIG. 3.

In another embodiment, the nail polish appliqué 1 may comprise: an adhesive layer 122 applied atop a removable substrate 120 (e.g. exposable when removing a back strip/substrate); a first nail enamel layer 124 applied atop said adhesive layer 122 and having a first color, said first enamel layer comprising partially or fully dried enamel; and, a second nail enamel layer 126 applied atop said first color layer and having a second color different from said first color, said second nail enamel layer comprising partially dried enamel of a different color than the first color. For example, the first color is a solid red, and the second color is blue translucent, such that the stone 2 appears purple.

In another embodiment as illustrated in FIG. 4, the second nail enamel layer 126 is translucent or neon color such that said first nail enamel layer 124 is at least partially visible through said second nail enamel layer, said first nail enamel layer blocking the passage of the adhesive layer 120 and the casting 18. The second nail enamel layer 126 covers the entire upper surface of said first nail enamel layer 124 such that said first and second colors of said first and second nail enamel layers, respectively, combine to provide an enhanced color appearance to said nail polish appliqué and stone. In an embodiment, as shown in FIG. 4, the first nail enamel layer and said second nail enamel layer are substantially oval or nail shaped, or cut to match the shape of the stone back surface. For example, the first nail enamel layer 124 may be a shade of white or color (e.g. red, green, blue, etc.); and/or the second nail enamel layer 126 comprises a metallic material selected from the group consisting of aluminum, copper, chrome, pewter and metallic flakes. Or the first nail enamel 124 layer comprises a metallic or glitter or fish scale finish; and the second nail enamel layer 126 is a colored translucent enamel or a clear top coat.

In another embodiment, the first nail enamel layer 124 comprises nail enamel in a shade of white or other color, and the second nail enamel layer 126 comprises neon-colored enamel having a translucent quality.

The nail appliqué may further comprise a topcoat (not shown) comprising clear nail enamel applied atop said second nail enamel layer 126; and/or a particulate material, such as mica or glitter.

The nail appliqués comprise an adhesive back that can stick to the casting's front surface 18, or to the back surface 14 of the stone; or the nail appliqués are otherwise permanently affixable to the stone back surface (e.g. compressed within stone frame/casting while semi dry, or due to the force of compression, or via clear glue on the stone back surface).

In an alternative embodiment, the nail appliqués comprise: an adhesive layer 124 applied atop a first nail enamel layer 122; and a removeable substrate 126 or clear plastic layer applied atop said adhesive layer, wherein the adhesive layer 124 is able to adhere to the back surface 14 of a jewelry stone upon removal of the substrate 126 or clear plastic layer. In this embodiment, the nail appliqué is manufactured with or without a bottom removeable or nonremovable substrate layer 120, such as a permanent layer affixed to the first nail enamel layer, that resides on the front surface 18 of the casting. A nonremovable substrate may have a decorative back surface visible, and it servers also to protect the nail appliqué from wear and tear.

In another embodiment, there may be two adhesive layers. For example, the bottom layer 120 may comprise another adhesive material such that the nail appliqué sticks to both the casting front surface 18 and the stone back surface 14 (e.g. two opposing adhesive layers); and a removeable substrate resides on one or both adhesive layers.

In summary, an adhesive layer may be used on the top or the bottom, or both the top and bottom surface of the nail appliqué. And a removeable substrate or clear plastic layer may cover the adhesive layer until it is ready to be applied to the back surface of the stone and/or casting. Or, a glue (or other adhesive) is applied to the stone back surface, and optionally the nail appliqué comprises a removeable substrate to stick to the casting back surface. Or the substrate remains on the nail appliqué bottom if there is no casting front surface 18 (e.g. the stone is too round to sit within a regular casting).

### Liquid Nail Polish

The stones of the present invention can alternatively be dipped or painted with liquid nail polish, and allowed to dry, before applying the metal casting 10 and 18 on the stone side and back surface. Liquid nail polish is widely known in the art of cosmetics, and may comprise a variety of colors, textures, and viscosities. Materials (e.g. glitter, foil bits, mica, etc.) can be applied to the liquid nail polish while it is drying.

In an embodiment, commercially available nail polishes suitable for use in the present invention comprise the following: about ¼-second and ½-second nitrocellulose (approx. 300-800 centipoise as measured by a Brookfield viscometer operating at 60 rpm). The designation of “second” indicates how long a metal ball will take to fall to the bottom of a given-sized drum of the material; the longer the period of time, the greater the viscosity of the nitrocellulose. Adjustments to the viscosity can be made with small amounts (i.e., 1-5 w/w %) higher viscosity nitrocelluloses i.e., 40-60 second and 60-80 second. Such high viscosity nitrocelluloses have never been used at higher concentration than 1-5% because the resulting nail polish would be too thick to apply by brush. The composition of a typical nail polish (also called nail enamel) is approximately 25-32% solids and 68-73% solvents. Of the solids, on a weight/weight percentage, 6-12% is nitrocellulose (¼-second or ½-second), about 6-12% is resin and 6-10% is plasticizer. The remaining contents are typically as follows: glitter, mica and color pigments 8-15%; ethyl acetate 20-30%; n-butyl acetate 20-30%; isopropyl alcohol 5-10%; and miscellaneous 3-7%; but other percentages and contents are well known in the art.

Other nail enamels are suitable for use with the present invention, such as those containing glyceryl, glycol or citrate esters (e.g. see U.S. Pat. No. 5,227,155, that issued on Jul. 13, 1993 to Revlon, the entire contents of which are hereby incorporated by reference in its entirety).

### Nail Appliqués

In an embodiment, nail appliqués of the present invention are made via a process as disclosed in U.S. Pat. No. 8,092,786 B2, that issued on Jan. 10, 2012, to the present inventor; the entire contents of which are hereby incorporated by reference in its entirety.

In an embodiment, the inventive high viscosity liquid nail enamel achieves its high viscosity in one of a number of ways. In some formulations, ¼ or ½-second nitrocellulose is used, but in substantially higher percentages by weight than conventional nail polish; that is, conventional polish may have 25-32% solids by weight, whereas the inventive nail enamel includes 35-60% solids by weight. In other formulations, 60-80 second nitrocellulose is used in much greater proportions than conventional nail polishes. That is, conventional nail polishes may use 60-80 second nitrocellulose at about 1-5% by weight merely to tweak the viscosity of the polish. However, the instant invention may employ 60-80 second nitrocellulose as a predominant or major solid in percentages as high as 6-25%. The use of more solids or a more viscous enamel provides greater durability and flexibility in the end product. Also, as a result of the inventive method, a greater percentage of solids in the enamel formulation results in a lower percentage of solvents being used. This lower solvent content has several advantages. From the standpoint of processing, the time required to complete drying/evaporation (i.e., to produce a finished product) is about 30-40% less than currently available liquid formulations. Second, the dry nail polish film of the present invention is better for the environment, since less solvents are released during the drying process.

Preferably, the formulations of nail enamel comprise at least 35% solid content by weight and/or 60-80 second nitrocellulose as a predominant solid. More preferably, the formulations of nail enamel comprise 60-80 second nitrocellulose at 6% or greater by weight.

Method of Making Jewelry Article with Nail Enamel

FIG. 3 illustrates a four-step exemplary process for using a nail appliqué applied to the stone comprising the use of a nail appliqué 1 with a silver glitter layer; an oval-shaped, faceted transparent synthetic stone 2; and a metal casting 10 and 18 surrounding the stone 2 side and back surface, respectively.

In step one, a multilayered nail appliqué 1 is provided comprising a layer of colored semi-dried or dried nail polish, and/or decorative material (e.g. glitter, mica, metallic foil layer or bits, pattern—such as shown in FIG. 1, etc.). The nail appliqué 1 may comprise on the bottom side, an adhesive layer (e.g. FIG. 4, 122) that is exposed when removing a back strip/substrate 120. And on nail appliqué l's top side that adheres to the stone back surface 14, may further comprise: 1) a top layer comprising a decorative material, or a second color, or a clear topcoat (e.g. FIG. 4, 126); or 2) a top layer comprising a decorative material or a first color (e.g. FIG. 4, layer 124, with no layer 126).

In step two, a stone 2 is provided, wherein the stone surface is cleaned, and may further comprise a clear adhesive (e.g. glue) applied to the back surface 14 of the stone.

In step three, the nail appliqué 1 is applied to the stone back surface 14, e.g. while the appliqué is still drying, or using glue on the stone back surface. In alternative embodiment, the nail appliqué is applied to the jewelry casting front surface 18 using the appliqué 's adhesive layer 122 (after removing the back strip or substrate FIG. 4, 120).

In an alternative embodiment, nail appliqué 1 may be allowed to completely dry, naturally by air exposure, or via mechanical means (e.g. ultraviolet light exposure, blow dryers, etc.) before affixing to the stone back surface 14 (e.g. when stone surface 14 is covered with glue). The casting may be made from a variety of decorative, metal materials well known in the art that also provide structural support to the jewelry by preventing the stones from dislodging, and by pressing the casting to the stone in addition to the use of adhesives for fixation.

In step four, the jewelry front surface 8 and/or sidewall casting 10 and/or front surface 18 are applied to the stone's back 14 and/or side surface 12 to permanently affix the (stone/nail appliqué/back metal casting) together as one unit. In the exemplification of FIGS. 2 and 3, the two stones 2a and 2b are joined together via the casting 10, 18; and appliqué 1 is affixed to the stone's side 12 and back surface 14 (e.g. from front to back: stone/nail applique/metal casting). The casting 8 (not shown) may also, or alternatively be applied to the stone's top surface 12. Preferably, appliqué 1 is applied to the stone while it is still in a semi-dry state so that the enamel adheres to the stone back surface 14 as part of the drying process.

The type of casting varies upon the stone shape, jewelry decoration, and requirements to keep the stones securely in place. T shape of the stone back surface 14 determines if a metal casting is just on the stone sides 12, or also on the stone back surface 14. For example, if stone 2 is oval, pearl, or dome shaped on both the front surface 16 and the back surface 14, then a backside metal casting 18 is not used (e.g. jewelry article 1 has metal casting sidewalls 10 only touching stone sides 12, thus exposing the nail appliqué bottom side on the back of the stone, which may comprise a decorative pattern or solid color). The appliqué substrate (FIG. 4, layer 120) would remain on the appliqué, and may further comprise a decorative pattern on the underside of layer 120.

And if the stone is a Cabochons, or the like (e.g., oval, pearl, or dome shaped extending outward from the top surface 16), with a flat back surface 14, then the metal casting comprises a flat metal piece front surface 18, and may further comprise castings sides 10 and/or casting top surface 8 for decoration and stability.

Although most jewelry casting is metal, other materials are well known in the art for fitting stones into jewelry articles.

The artisan would also readily know of methods of substituting liquid nail enamel for the nail appliqués to use the method of making disclosed herein, which would not normally require the use of adhesives. For example, the stone back surface 14 would be painted or dipped into liquid nail enamel, allowed to dry, and then affixed into the metal casting.

While this invention has been described in connection with a preferred embodiment, it is not intended to limit the scope of the invention to the particular form set forth, but, on the contrary, is intended to cover such alternatives, modifications and equivalents as may be included within the spirit and scope of the invention as defined by the appended claims.

What is claimed herein is:

1. A multilayered jewelry article with decorative stones, comprising,
one or more clear and/or opaque stones 2, faceted and/or non-faceted, each stone comprising a front surface 16, a back surface 14, and a side 12, and one or more types of: a glass piece, a plastic piece, a synthetic lab produced stone, and a natural product of nature;
a casting comprising one or more of: a side 10, a top surface 8, and/or a front surface 18, said casting able to securely connect the stone(s) to a jewelry article; and
a nail appliqué 1, or a liquid nail polish, able to be secured to the stone back surface 14 or to the casting front surface 18 that is affixed to the stone back surface 14, wherein the nail appliqué or polish comprise a color and/or a pattern visible on the stone front surface that enhances the decorative appearance of the stone and jewelry article.

2. The jewelry article of claim 1, wherein the stone is substantially flat shaped on the back surface, and the casting comprises a casting front surface.

3. The jewelry article of claim 1, wherein the stone is substantially curve shaped on the back surface, and the casting consists of a casting sidewall and/or a casting top surface, and the nail appliqué or the liquid nail polish adheres to the stone back surface.

4. The jewelry article of claim 1, wherein the nail appliqué comprises an adhesive layer 122 applied atop a removable substrate 120; and a first nail enamel layer 124 applied atop said adhesive layer and having a first color, said first enamel layer comprising partially dried or fully dried enamel; and wherein the adhesive layer is able to adhere to the jewelry casting back surface 18 upon removal of the substrate.

5. The jewelry article of claim 4, further comprising a second nail enamel layer 126 having a second color different than said first color, or a metallic layer 126, applied atop said first enamel layer 124, said second enamel layer comprising partially dried or fully dried colored, clear, opaque, or neon enamel.

6. The jewelry article of claim 5, wherein the metallic layer comprises a glitter, a mica, a metallic foil layer or bits, or a decorative pattern.

7. The jewelry article of claim 1, wherein the nail appliqué comprises an adhesive layer 122 applied atop a removable substrate 120; and a first metallic layer 124 applied atop said adhesive layer; and wherein the adhesive layer is able to adhere to the jewelry casting front surface 18 upon removal of the substrate, and wherein the metallic layer comprises a glitter, a mica, a metallic foil layer or bits, or a decorative pattern.

8. The jewelry article of claim 7, further comprising a first nail enamel layer 126 having a first color, applied atop said metallic layer 124, said first enamel layer comprising partially dried or fully dried colored, clear, opaque, or neon enamel.

9. The jewelry article of claim 1, wherein the stone back surface further comprises clear adhesive applied to the stone.

10. The jewelry article of claim 1, wherein the stone back surface further comprises liquid colored nail enamel painted or dipped onto said stone back surface.

11. A method of making a multilayered jewelry article comprising an enhanced decorative appearance, comprising:
a. providing:
one or more clear and/or opaque stones 2, faceted and/or non-faceted, each stone comprising a front surface 16, a back surface 14, and a side 12, and one or more types of: a glass piece, a plastic piece, a synthetic lab produced stone, and a natural product of nature;
a casting comprising one or more of: a side 10, a top surface 8, and/or a front surface 18, said casting able to securely connect the stone(s) to a jewelry article;
a nail appliqué 1, or a liquid nail polish, able to be secured to the stone back surface 14 or to the casting front surface 18 that is affixed to the stone back surface 14, wherein the nail appliqué or polish comprise a color and/or a pattern visible on the stone front surface that enhances the decorative appearance of the stone and jewelry article;
b. applying the liquid nail polish or the nail appliqué to the stone back surface 14, or applying the nail appliqué to the casting front surface 18;
c. affixing the casting to the stone back surface 14, and/or sides 10, and/or front surface 16 to create a multilayered jewelry article comprising: the stone(s), the nail polish or the nail appliqué, and the casting; and
d. wherein the nail polish, or the nail appliqué, provides an enhanced decorative appearance to the stone(s).

12. The method of claim 11, wherein the nail appliqué comprises an adhesive layer 122 applied atop a removable substrate 120; and a first nail enamel layer 124 applied atop said adhesive layer and having a first color, said first enamel layer comprising partially dried or fully dried enamel; and wherein the adhesive layer is able to adhere to the jewelry casting back surface 18 upon removal of the substrate.

13. The method of claim 12, further comprising a second nail enamel layer 126 having a second color different than said first color, or a metallic layer 126, applied atop said first enamel layer 124, said second enamel layer comprising partially dried or fully dried colored, clear, opaque, or neon enamel.

14. The method of claim 13, wherein the metallic layer comprises a glitter, a mica, a metallic foil layer or bits, or a decorative pattern.

15. The method of claim 11, wherein the nail appliqué comprises an adhesive layer 122 applied atop a removable substrate 120; and a first metallic layer 124 applied atop said adhesive layer; and wherein the adhesive layer is able to adhere to the jewelry casting back surface 18 upon removal of the substrate.

16. The method of claim 15, wherein the metallic layer comprises a glitter, a mica, a metallic foil layer or bits, or a decorative pattern.

17. The method of claim 15, further comprising a first nail enamel layer 126 having a first color, applied atop said metallic layer 124, said first enamel layer comprising partially dried or fully dried colored, clear, opaque, or neon enamel.

18. The method of claim 11, wherein further comprising applying clear adhesive to the stone back surface, and the nail appliqué atop the adhesive.

19. The method of claim 11, wherein the jewelry article comprises colored liquid nail polish painted or dipped onto the stone back surface.
